(19) United States
(12) Patent Application Publication
(10) Pub. No.: US 2026/0245751 A1
(43) Pub. Date: Aug. 20, 2026

(54) SPIRAL NTP FUEL FOR POWER FLATTENING

(71) Applicant: Standard Nuclear, Inc., Oak Ridge, TN (US)

(72) Inventors: Gavin GARSIDE, Cottonwood Heights, UT (US); Ethan CHALEFF, Groveland, CA (US); Tom HINKLIN, Sandy, UT (US); Michael John EADES, Seattle, WA (US); Kurt A. TERRANI, Knoxville, TN (US)

(73) Assignee: Standard Nuclear, Inc., Oak Ridge, TN (US)

(21) Appl. No.: 19/122,614

(22) PCT Filed: Sep. 8, 2023
(86) PCT No.: PCT/US2023/032249

§ 371 Date: Apr. 18, 2025

Related U.S. Application Data
(60) Provisional application No. 63/405,164, filed on Sep. 9, 2022.

(51) Int. Cl. G21C 3/322; G21C 7/32; G21C 15/243

(52) U.S. Cl. CPC G21C 3/322; G21C 7/32; G21C 15/243

(57) ABSTRACT

A fuel element includes a plurality of coolant channels formed therein. Each of the coolant channels rotate around a longitudinal axis of the fuel element such that a lateral position of a respective coolant channel changes at different longitudinal levels along the longitudinal axis. In one example, the respective coolant channel substantially helically winds around the longitudinal axis. In another example, the changing lateral position of the respective coolant channel forms at least one twist along the longitudinal axis configured to smear a thermal profile of the fuel element to balance power distribution within the fuel element. For example, the at least one twist is configured to spiral a flow of a coolant or a propellant through the fuel element to temperature balance hot and cold spots in a nuclear reactor core. A fabrication method for the fuel element can include additive manufacturing.

### CROSS-REFERENCE TO RELATED APPLICATIONS

This application claims priority to U.S. Patent Provisional Application No. 63/405,164, filed on Sep. 9, 2022, titled “Spiral NTP Fuel for Power Flattening,” the entirety of which is incorporated by reference herein. This application relates to International Application No. PCT/US2023/XXXXXX, filed on Sep. 8, 2023, titled “Ordered Particle Fuel,” the entirety of which is incorporated by reference herein.

### TECHNICAL FIELD

The present subject matter relates to examples of nuclear reactor systems and nuclear reactors for power production and propulsion, e.g., in remote regions, such as outer space. The present subject matter also encompasses a nuclear fuel element that includes coolant channels that rotate around a longitudinal axis of the fuel element.

### BACKGROUND

The performance of nuclear thermal propulsion (NTP), as well as other extremely high-temperature nuclear heating applications is directly related to the maximum temperature of the coolant (e.g., propellant). For example, in NTP, the thrust efficiency (e.g., specific impulse (Iₛₚ)) is directly related to the ultimate temperature achieved of the coolant.

In NTP, for example, exhaust temperatures greater than 2,700 Kelvin (K) are desired (e.g., for interplanetary travel), which puts a significant limit on the types of materials that are acceptable. If exhaust temperatures exceed 2,700 K, then the fuel bearing material will necessarily become even hotter. Because most materials are unstable at temperatures exceeding 2,700 K and conditions of flowing a coolant (e.g., hydrogen (H₂)), the amount of temperature over 2,700 K directly affects fuel rod lifetimes and fission product retention in a nuclear reactor core.

FIG. 1A is a graph that quantifies Iₛₚ loss for two types of NTP system implementations. The two types of NTP systems shown in FIG. 1A are Space Capable Cryogenic Thermal Engine (SCCTE) and Tiny Rocket Investigating Balanced Launch Economics (TRIBLE) designs. Typically, all fuel elements of a nuclear reactor core have the same normalized power element when control drums are at a 90 degree orifice angle, meaning the control drums are halfway out. The as designed nominal position of control drums is referred to as the “orifice angle” because it is the control drum angle, and resultant spatial power distribution, that is used to determine the orificing for each channel.

FIG. 1B shows power distribution with the SCCTE type of NTP system when the control drums are at 90 degrees. As shown in FIGS. 1A-B, every fuel element has the same normalized power per element because 90 degrees is the radial power distribution that the orificing was designed to.

However, as shown in FIG. 1C, as the control drums rotate out (30 degrees), letting more neutrons be reflected back, the fuel elements on the periphery get a larger fraction of the power than they received at the orifice angle, which results in power peaking in the periphery of the core. Moreover, as shown in FIG. 1D, as the control drums rotate in (150 degrees), letting less neutrons be reflected back into the core, the fuel elements on the periphery get a smaller fraction of the power than they received at the orifice angle.

Left unaddressed, in element power peaking leads to hot spots in the fuel and uneven propellant exit temperatures, which can impact specific impulse. The problem has traditionally been solved by orificing individual propellant channels. Because orificing is typically static, flow is increased to the entire core when flow is increased to a single fuel element. To increase the flow to single fuel element would require complicated active valving. Moreover, when the control drums rotate, the radial power deposition changes rendering the channel orificing ineffective because the orificing no longer aligns with the radial power deposition. The change in radial power deposition results in some channels receiving more power than the orificed flow can take away.

Other alternatives to solve in element power peaking involve extremely precise fuel loading and enrichment zoning, but both of those alternatives add additional complexities. Accordingly, improvements to fuel elements for the nuclear reactor core are needed to reduce power peaking and optimize performance.

### SUMMARY

The need for promoting the radial heat transfer flattening in a fuel element 104 increases as the size of the nuclear reactor 107 is minimized. In addition, a sharp gradient in a power flux within individual fuel elements 104A-N is created as a fuel rod radial position increases within the nuclear reactor 107 and approaches the control surfaces or any material or geometric disturbance within the nuclear reactor 107.

Accordingly, a nuclear fuel element 104 implements a spiral coolant channel geometry 144 to homogenize fuel temperature and thermal output by spiraling coolant channels 141A-N. Spiral coolant channel geometry 144 reduces power peaking and optimizes performance of a nuclear reactor system 100, such as NTP, by improving reliability and efficiency of a nuclear reactor 107. Spiral coolant channel geometry 144 can balance spatial heating variations in fuel elements 104A-N within a nuclear reactor core 101. For example, the spiraling of coolant channels 141A-N can solve the problem of macro radial peaking in a nuclear reactor 107 with non-linear shaped coolant channels 141A-N that swirl, e.g., implement a twist 148.

In the spiral coolant channel geometry 144, an axis of coolant channels 141A-N (e.g., for fuel cooling or coolant heat transfer) is not orthogonally aligned with the direction of net motion of coolant (e.g., propellant). Instead, the coolant channels 141A-N are angled to rotate (e.g., spiral) about a longitudinal axis 145 (e.g., primary axis) of the fuel element 104. The rotation causes a homogenization of the temperature within both structures and/or coolant within a ring of coolant channels 141A-N. Additionally, the spiral coolant channel geometry 144 leads to an increase in path length 196, which increases heat transfer surface area, allowing more fuel to operate at a lower temperature for the same heat provided.

As few as a single turn (e.g., twist 148) results in near perfect thermal flattening of the output within a ring of coolant channels 141A-N. In some examples, temperatures between concentric rings may not be homogenized by the spiral coolant channel geometry 144. However, the spiral coolant channel geometry 144 homogenizes each coolant channel 141A-N within a ring. Hence, the spiral coolant channel geometry 144 simplifies the challenge of homogenizing fuel with multiple rings of coolant channels 141A-N by well over an order of magnitude, for example a reduction in complexity from order 61 to order 4.

An example fuel element 104 that implements the spiral coolant channel geometry 144 includes a plurality of coolant channels 141A-N formed therein. Each of the coolant channels 141A-N rotate around a longitudinal axis 145 of the fuel element 104 such that a lateral position 147A-N of a respective coolant channel 141A-N changes at different longitudinal levels 192A-N along the longitudinal axis 145. Coolant channels 141A-N that are helical shaped can distribute heat evenly through the fuel element 104 and eliminate the need for orificing each coolant channel 141A-N.

An example spiral coolant channel fabrication method 1200 for the fuel element 104 includes three-dimensional printing a green body 199 of the fuel element 104 to form at least one twist 148 in the plurality of coolant channels 141A-N. The spiral coolant channel fabrication method 1200 further includes placing a plurality of fuel particles 151A-N in selected locations in the fuel element 104.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A is a graph that quantifies Isp loss for two types of NTP systems.

FIG. 1B shows power distribution for an NTP system when the control drums are at 90 degrees.

FIG. 1C shows power distribution the NTP system when the control drums are at 30 degrees.

FIG. 1D shows power distribution for the NTP system when the control drums are at 150 degrees.

FIG. 2 is a cross-sectional view of a nuclear reactor core of a nuclear reactor system that includes fuel elements with a spiral coolant channel geometry.

FIG. 3A is a zoomed in view of the nuclear reactor core of FIG. 2 showing details of a single fuel element that includes coolant channels with the spiral coolant channel geometry and a random fuel particle packing.

FIG. 3B is a zoomed in view of the nuclear reactor core of FIG. 2 showing details of a single fuel element that includes coolant channels with the spiral coolant channel geometry and an ordered fuel particle packing.

FIG. 4A is a cutaway view of a single fuel element similar to that of FIG. 3A that depicts the spiral coolant channel geometry and the random fuel particle packing.

FIG. 4B is a zoomed in view of a detail area of the fuel element of FIG. 4A with the fuel particles arranged in the random fuel particle packing.

FIG. 5A is a cutaway view of a single fuel element similar to that of FIG. 3B that depicts the spiral coolant channel geometry and the ordered fuel particle packing.

FIG. 5B is a zoomed in view of a detail area of the fuel element of FIG. 5A with the fuel particles arranged in the ordered fuel particle packing.

FIG. 6 is an isometric view of a single fuel element similar to that of FIGS. 4A-B and 5A-B and showing details of the coolant channels helically winding around a longitudinal axis.

FIG. 7 compares a path length of a coolant channel with a length of a fuel element that implements the spiral coolant channel geometry.

FIG. 8A is a cross-sectional view of a single fuel element similar to that of FIGS. 4A-B showing details of coolant channels.

FIG. 8B is a cross-sectional view of a single fuel element similar to that of FIGS. 5A-B showing details of coolant channels and fuel particle matrices.

FIG. 8C is a cross-sectional view of a fuel element like that of FIGS. 5A-B with an ordered fuel particle packing in which a fuel particle matrix has a laterally nested geometry.

FIG. 9A is an isometric view of a green form of a single fuel element that includes coolant channels.

FIG. 9B is a top view of the green form of FIG. 9A showing details of the coolant channels.

FIG. 9C is a cutaway view of the green form of FIGS. 9A-B showing details of the green form and the coolant channels formed therein with a helical shape.

FIG. 9D is a top view of a single coolant channel of the green form of FIGS. 9A-C.

FIG. 10A is a diagram of a heat generation map for a fuel element with a spiral coolant channel geometry.

FIG. 10B is a diagram of a fuel temperature profile for the fuel element of FIG. 10A with the spiral coolant channel geometry.

FIG. 11 is diagram of a power peaking factor for a fuel element with the spiral coolant channel geometry.

FIG. 12 is a flowchart of a spiral coolant channel fabrication method for a fuel element.

### Parts Listing

100 Nuclear Reactor System
101 Nuclear Reactor Core
102A-N Insulator Elements
103A-N Moderator Elements
104A-N Fuel Elements
107 Nuclear Reactor
111A-N Fuel Particle Matrices
112 Insulator Element Array
113 Moderator Element Array
114 Fuel Element Array
115A-N Control Drums
116 Reflector Material
117 Absorber Material
135A-N Control Drum Channels
140 Reflector
141A-N Coolant Channels
144 Spiral Coolant Channel Geometry
145 Longitudinal Axis
146 Lateral Axis
147A-N Lateral Position
148 Twist
151A-N Fuel Particles
152 Encapsulation Matrix (e.g., High-Temperature Matrix)
153 Helical Shape
156 Twisted Geometry
157 Ordered Fuel Particle Packing
158 Random Fuel Particle Packing
160 Pressure Vessel
181 Cluster
182 Population Number
183 Population Density
192A-N Longitudinal Levels (e.g., Axial Positions)
193 Length (e.g., Height)
195 Lateral Distance
196 Path Length
197 Laterally Nested Geometry
198 Ablation Layer
199 Green Form (e.g., Green Body)
1000A Heat Generation Map
1000B Fuel Temperature Profile
1100 Power Peaking Factor
1105 Number of Turns
1110 Coolant Channel Peaking Factor
1115 Maximum Channel Peaking
1120 Minimal Channel Peaking
1200 Spiral Coolant Channel Fabrication Method

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical, physical, or electrical connection. Unless described otherwise, coupled elements or devices are not necessarily directly connected to one another and may be separated by intermediate components, elements, etc.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” or “substantially” mean that the parameter value or the like varies up to ±25% from the stated amount. When used in connection with comparing two or more parameter values, the term “substantially uniform” means the parameter values vary up to ±25% from each other. When used in connection with a direction, “substantially longitudinally” means generally vertical to a point of reference, for example, in a substantially orthogonal or perpendicular direction that is 81°-99° to the point of reference. When used in connection with a direction, “substantially laterally” means generally horizontal to a point of reference, for example, in a substantially sideways or parallel direction, that is 162°-198° to the point of reference. When used in connection with a direction, “substantially helically” means generally turning around a point of reference.

Although A is the first letter of the alphabet and Z is the twenty-sixth letter of the alphabet, due to the restriction of the alphabet, the designation “A-N” when following a reference number, such as 102, 104, 111, 141, 151, etc. can refer to more than twenty-six of those identical elements.

The orientations of the nuclear reactor system 100, nuclear reactor core 101, nuclear reactor 107, fuel elements 104A-N, fuel particles 151A-N, coolant channels 141A-N, associated components, and/or any nuclear reactor system 100 incorporating a spiral coolant channel geometry 144, such as shown in any of the drawings, are given by way of example only, for illustration and discussion purposes. In operation for a particular nuclear reactor system 100, the components may be oriented in any other direction suitable to the particular application of the nuclear reactor system 100, for example upright, sideways, or any other orientation. Also, to the extent used herein, any directional term, such as lateral, longitudinal, up, down, upper, lower, top, bottom, and side, are used by way of example only, and are not limiting as to direction or orientation of any nuclear reactor system 100 or component of the nuclear reactor system 100 constructed as otherwise described herein. Reference now is made in detail to the examples illustrated in the accompanying drawings and discussed below.

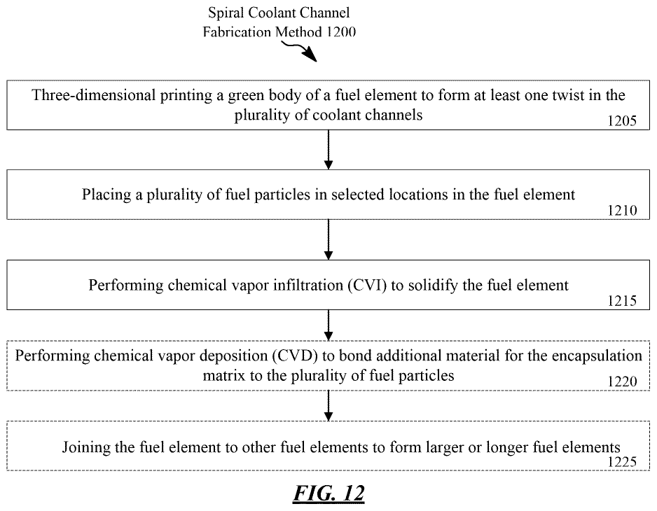

FIG. 2 is a cross-sectional view of a nuclear reactor core 101 of a nuclear reactor system 100 that includes fuel elements 104A-N with a spiral coolant channel geometry 144. The spiral coolant channel geometry 144 angles coolant channels 141A-N of fuel elements 104A-N to form a spiral. Such spiraling of the coolant channels 141A-N can advantageously eliminate the need to orifice individual coolant channels 141A-N. As described later in FIG. 12, a spiral coolant channel fabrication method 1200 for the fuel elements 104A-N can achieve spiraling of the coolant channels 141A-N with additive manufacturing techniques.

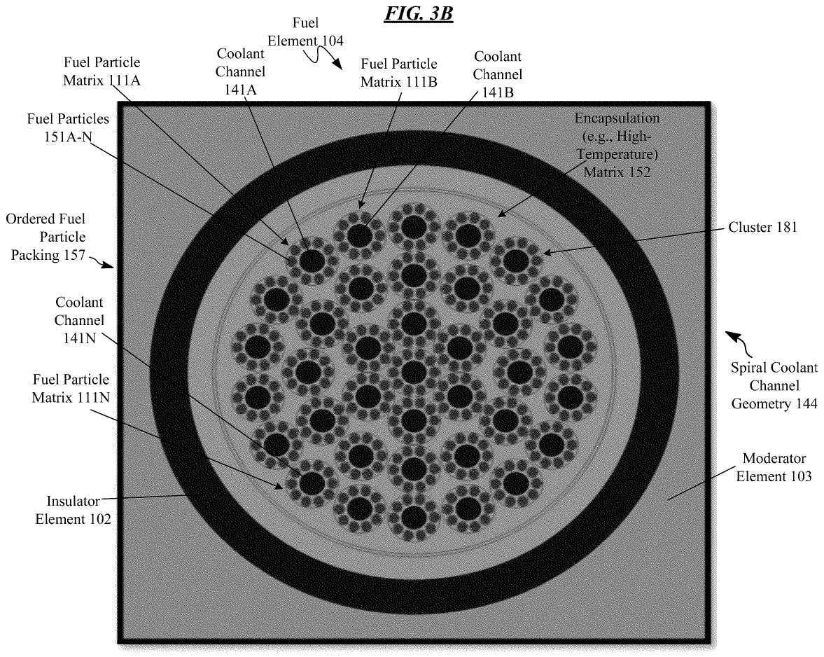

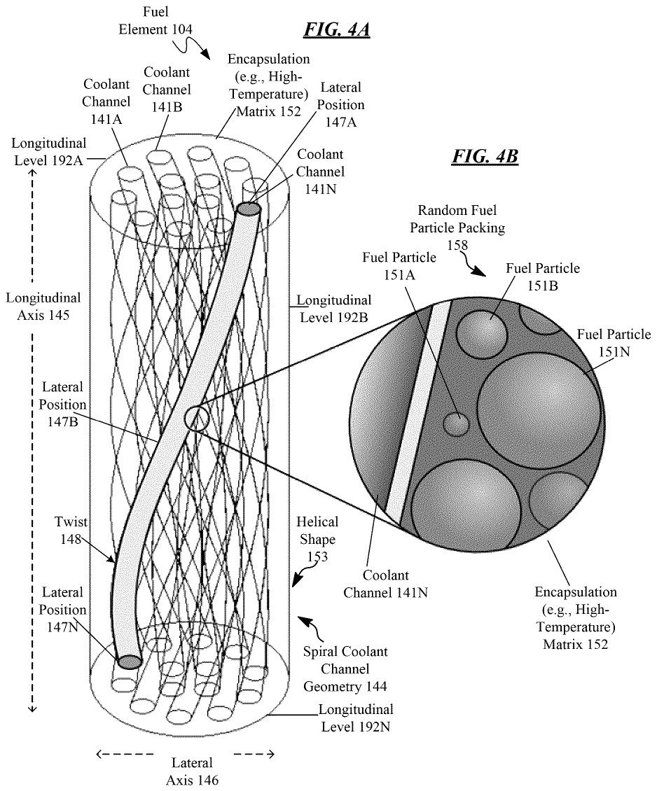

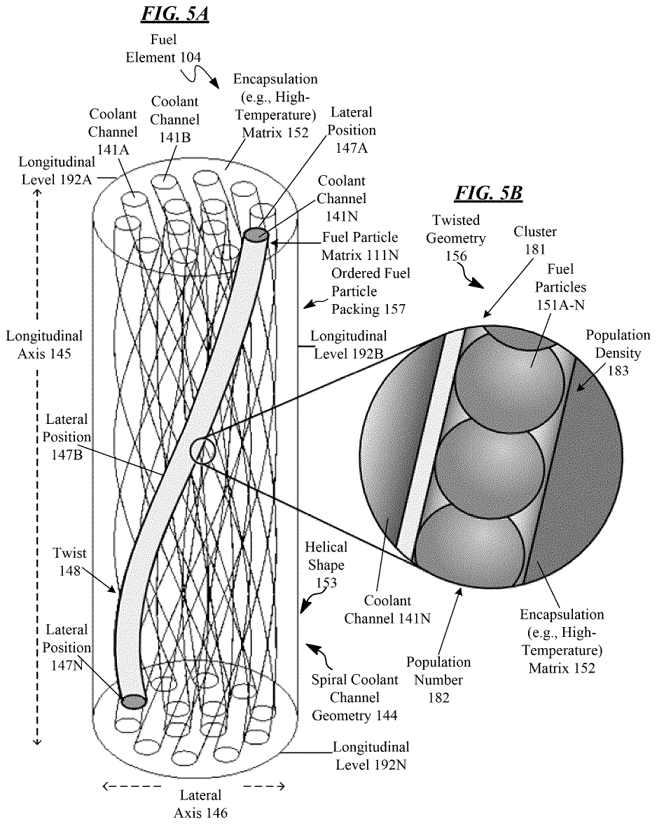

Nuclear reactor system 100 includes a nuclear reactor 107. Fuel elements 104A-N in the nuclear reactor core 107 can implement a random fuel particle packing 158 (see FIGS. 4A-B) in which the fuel particles 151A-N are randomly packed. Alternatively, fuel elements 104A-N can implement an ordered fuel particle packing 157 (see FIGS. 5A-B) to enable the nuclear reactor 107 to operate where the nuclear fuel operates as close as possible to the maximum possible temperature it can survive during normal operation

Nuclear reactor 107 includes the nuclear reactor core 101, in which a controlled nuclear chain reaction occurs, and energy is released. The neutron chain reaction in the nuclear reactor core 101 is critical—a single neutron from each fission nucleus results in fission of another nucleus—the chain reaction must be controlled.

By sustaining controlled nuclear fission, the nuclear reactor system 100 produces heat energy. In an example implementation, the nuclear reactor system 100 is implemented as a gas-cooled nuclear reactor 107 where coolant is a gas to achieve performance gains. The spiral coolant channel geometry 144 technology can also enable breakthrough performance in other thermal spectrum nuclear reactor systems 100, including large utility scale reactors, heat pipe reactors, and molten-salt-cooled reactors.

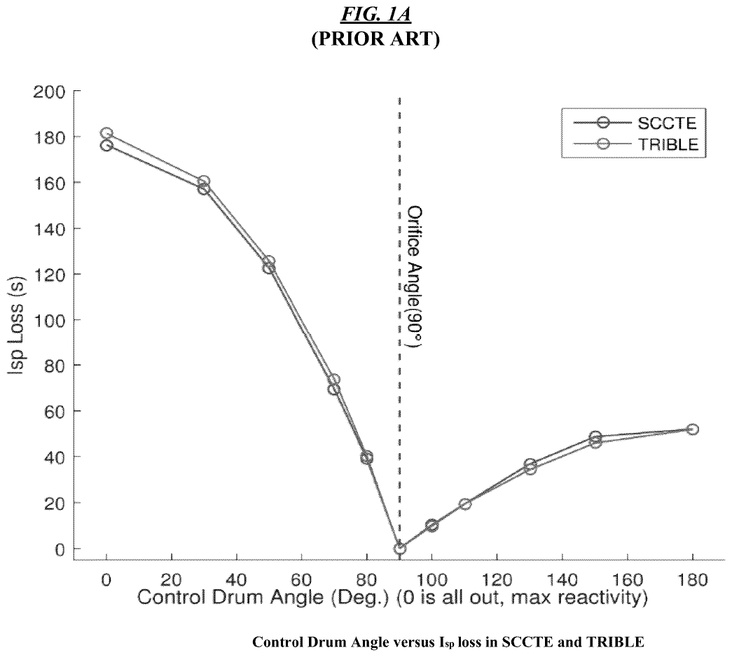

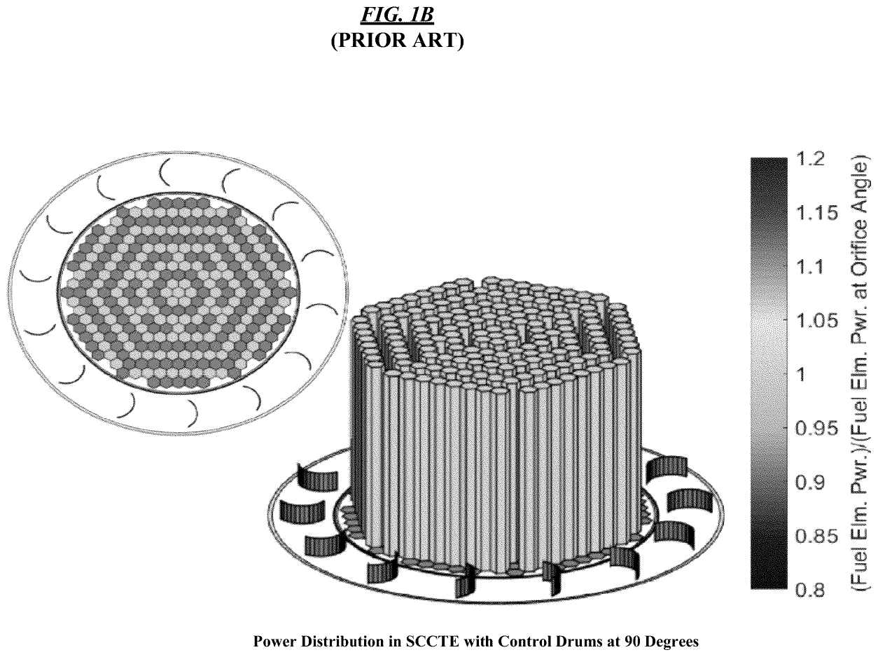

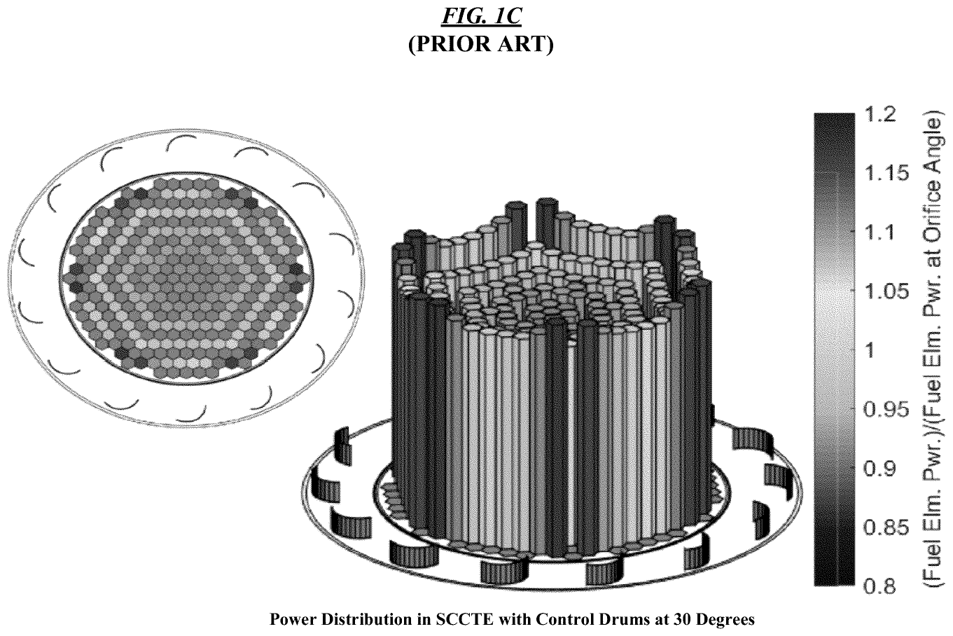

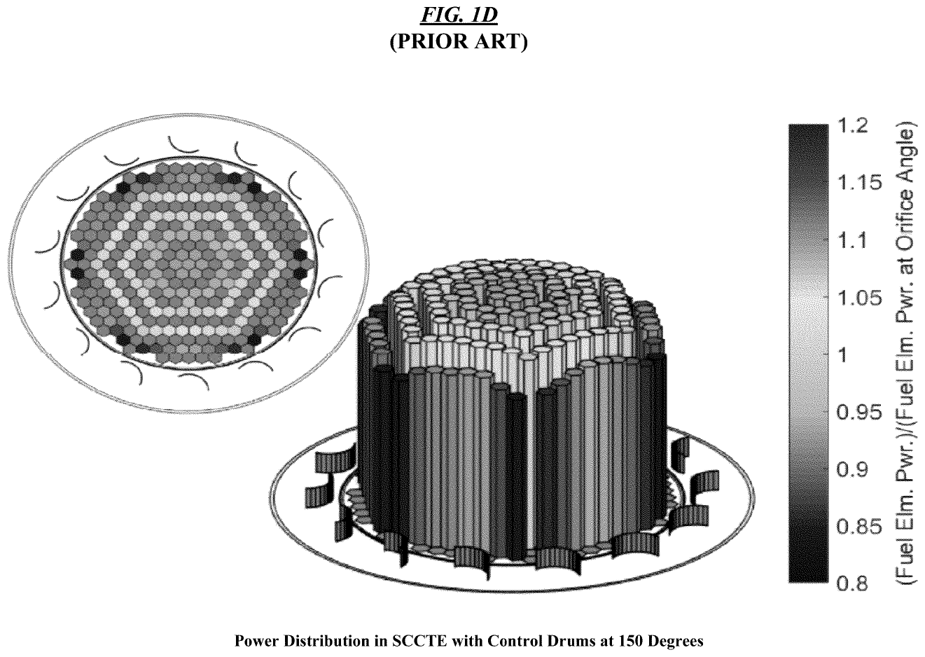

In the depicted example, the nuclear reactor system 100 with the nuclear reactor core 101 is utilized in a space environment, such as in a nuclear thermal propulsion (NTP) system. An example NTP system that the ordered fuel particle packing 157 of the nuclear reactor core 101 can be implemented in is described in FIGS. 1-2 and the associated text of U.S. Pat. No. 10,643,754 to Ultra Safe Nuclear Corporation of Seattle, Washington, issued May 5, 2020, titled “Passive Reactivity Control of Nuclear Thermal Propulsion Reactors” the entirety of which is incorporated by reference herein. In another example, the nuclear reactor system 100 with the nuclear reactor core 101 is utilized in a space reactor for electrical power production on a planetary surface.

Conventional space reactor designs typically utilize highly-enriched uranium (HEU) fuel (weapons grade) to have both low-mass and high-temperature output. The architecture for the nuclear reactor core 101 described herein can use HEU fuel, but is directly applicable to enabling the development of low-mass, high-temperature, low-enriched uranium (LEU) fueled (non-weapons grade) nuclear reactors to increase efficiency and can be designed specifically for space applications. For example, the nuclear reactor system 100 that includes the nuclear reactor core 101 can be a nuclear thermal rocket reactor, nuclear electric propulsion reactor, Martian surface reactor, or lunar surface reactor.

In such an NTP system (e.g., compact space nuclear reactor), a generated thrust propels a vehicle that houses, is formed integrally with, connects, or attaches to the nuclear reactor core 101, such as a rocket, drone, unmanned air vehicle (UAV), aircraft, spacecraft, missile, etc. Typically, this is done by heating a propellant, typically low molecular weight hydrogen, to over 2,600° Kelvin by harnessing thermal energy from the nuclear reactor core 101. In addition, the NTP nuclear reactor system 100 can be used in the propulsion of submarines or ships.

As noted above, the nuclear reactor system 100 can also be a nuclear power plant in a terrestrial land application, e.g., for providing nuclear power (e.g., thermal and/or electrical power) for remote region applications, including outer space, celestial bodies, planetary bodies, and remotes regions on Earth. An example terrestrial land nuclear reactor system that the spiral coolant channel geometry 144 of the nuclear reactor core 101 can be implemented in is described in FIG. 1A and the associated text of U.S. Pat. No. 11,264,141 to Ultra Safe Nuclear Corporation of Seattle, Washington, issued Mar. 1, 2022, titled “Composite Moderator for Nuclear Reactor Systems,” the entirety of which is incorporated by reference herein.

Nuclear reactor system 100 can also be a terrestrial power system, such as a nuclear electric propulsion (NEP) system for fission surface power (FSP) system. NEP powers electric thrusters such as a Hall-effect thruster for robotic and human spacecraft. FSP provides power for planetary bodies such as the moon and Mars. In the NEP and FSP power applications, the nuclear reactor system 100 enabled with the spiral coolant channel geometry 144 technology heats a working fluid (e.g., He, HeXe, Ne, CO₂) through a power conversion system (e.g., Brayton) to produce electricity. Moreover, in the NEP and FSP power applications, the nuclear reactor system 100 does not include a propellant, but rather includes a working fluid that passes through a reactor inlet when producing power. In the NEP and FSP power applications, the fuel elements 104A-N can be cooled via the reactor inlet working fluid (e.g., the flow coming out of a recuperator).

Utilizing the spiral coolant channel geometry 144 technology described herein enables a nuclear reactor system 100 that is high-temperature, compact, accident tolerant, and operates safely and reliably throughout the lifetime of the nuclear reactor system 100. For example, the nuclear reactor core 101 can be within a small commercial fission power system for near term space operations, lunar landers, or a commercial fission power system for high-power spacecraft and large-scale surface operations, such as in-situ resource utilization.

Nuclear reactor core 101 includes an insulator element array 112 of insulator elements 102A-N and a moderator element array 113 of moderator elements 103A-N. Moderator elements 103A-N can be blocks or various other shapes formed of, for example, a low-temperature solid-phase moderator. However, moderator elements 103A-N are not limited to being a low-temperature moderator, and can be a high-temperature or moderate temperature moderator. Moderator elements 103A-N can include low density carbides, metal-carbides, metal-oxides, or a combination thereof. The moderator elements 103A-N can include any solid neutron-moderating materials, such as graphite; other forms of carbon such as industrial diamond or amorphous carbon, beryllium metal, beryllium oxide; beryllides, such as beryllium-zirconium; hydrides such as zirconium hydride or yttrium hydride; or compounds and composite materials containing neutron moderating materials, such as hydrides or beryllides in a high-temperature matrix such as MgO, SiC, or ZrC. Moderator elements 103A-N can include low density SiC, stabilized zirconium oxide, aluminum oxide, low density ZrC, low density carbon, or a combination thereof. Moderator elements 103A-N can also be formed of a low-temperature solid-phase moderator, including MgHₓ, YHₓ, ZrHₓ, CaHₓ, ZrOₓ, CaOₓ, BeOₓ, BeCₓ, Be, enriched boron carbide, ¹¹B₄C, CeHₓ, LiHₓ, or a combination thereof.

Insulator elements 102A-N can be formed of a high-temperature thermal insulator material with low thermal conductivity. The high-temperature thermal insulator material can include low density carbides, metal-carbides, metal-oxides, or a combination thereof. More specifically, the high-temperature thermal insulator material includes low density SiC, stabilized zirconium oxide, aluminum oxide, low density ZrC, low density carbon, or a combination thereof.

In this nuclear reactor system 100, the nuclear reactor 107 can include a plurality of control drums 115 and a reflector 140. For example, in an NTP, NEP, or FSP nuclear reactor system 100, the nuclear reactor 107 can include the plurality of control drums 115A-N that occupy a plurality of control drum channels 135A-N. Control drums 115A-N are rotated within the control drum channels 135A-N. The control drums 115A-N may laterally surround the fuel element array 114 of fuel elements 104A-N to change reactivity of the nuclear reactor core 101 by rotating the control drums 115A-N. As depicted, the control drums 115A-N reside on the perimeter or periphery of a pressure vessel 160 and are positioned circumferentially around the fuel elements 104A-N of the nuclear reactor core 101. Control drums 115A-N may be located in an area of an optional reflector 140, e.g., an outer reflector region immediately surrounding the nuclear reactor core 101, to selectively regulate the neutron population and nuclear reactor power level during operation.

For example, the control drums 115A-N can be a cylindrical shape and formed of both a reflector material 116 (e.g., beryllium (Be), beryllium oxide (BeO), BeSiC, BeMgO, Al₂O₃, etc.) on a first outer surface and an absorber material 117 on a second outer surface. The reflector material 116 and the absorber material 117 can be on opposing sides of the cylindrical shape, e.g., portions of an outer circumference, of the control drums 115A-N. The reflector material 116 can include a reflector substrate shaped as a cylinder or a truncated portion thereof. The absorber material 117 can include an absorber plate or an absorber coating. The absorber plate or the absorber coating are disposed on the reflector substrate to form the cylindrical shape of each of the control drums 115A-N. For example, the absorber plate or the absorber coating covers the reflector substrate formed of the reflector material to form the control drums 115A-N.

Rotating the depicted cylindrical-shaped control drums 115A-N changes proximity of the absorber material 117 (e.g., boron carbide, B₄C) of the control drums 115A-N to the nuclear reactor core 101 to alter the amount of neutron reflection. When the reflector material 116 is inwards facing towards the nuclear reactor core 101 and the absorber material 117 is outwards facing, neutrons are scattered back (reflected) into the nuclear reactor core 101 to cause more fissions and increase reactivity of the nuclear reactor core 101. When the absorber material 117 is inwards facing towards the nuclear reactor core 101 and the reflector material 116 is outwards facing, neutrons are absorbed and further fissions are stopped to decrease reactivity of the nuclear reactor core 101. In a terrestrial land application, the nuclear reactor core 101 may include control rods (not shown) composed of chemical elements such as boron, silver, indium, and cadmium that are capable of absorbing many neutrons without themselves fissioning.

Neutron reflector 140 (optional), can be filler elements disposed between outermost fuel elements 104A-N and control drums 115A-N as well as around control drums 115A-N. Reflector 140 can be formed of a moderator that is disposed between the outermost moderator elements 103A-N and an optional barrel (e.g., formed of beryllium). The reflector 140 can include hexagonal or partially hexagonal shaped filler elements and can be formed of a neutron moderator (e.g., beryllium oxide, BeO). Although not required, nuclear reactor 107 can include the optional barrel (not shown) to surround the bundled collection that includes the insulator elements 102A-N, moderator elements 103A-N, and fuel elements 104A-N of the nuclear reactor core 101, as well as the reflector 140.

Pressure vessel 160 can be formed of aluminum alloy, carbon-composite, titanium alloy, a radiation resilient SiC composite, nickel based alloys (e.g., Inconel™ or Haynes™), or a combination thereof. Pressure vessel 160 and the nuclear reactor core 101 can be comprised of other components, including cylinders, piping, and storage tanks that transfer a coolant, such as a propellant (e.g., hydrogen gas or liquid), that flows through the coolant channels 141A-N.

In a nuclear reactor system 100, such as an NTP system, any fuel design which lowers peak temperature while maintaining average coolant (e.g., propellant) outlet temperature is likely to buy margin and reduce risk. With many exponential processes in these regions, every degree of minimization of peak temperature to achieve a given outlet temperature is valuable. Thus, to keep the fuel particles 151A-N as cool as possible, the thermal distributions within the fuel element 104 and across fuel elements 104A-N in all operating modes needs to be minimized. If there were variation, with both hot and cold spots, to keep the same average temperature, the hot spots would need to be hotter to average out cold spots. Thus, decreasing thermal resistance and increasing thermal uniformity are typically key design goals.

If the power distribution of these hot and cold spots is known apriori, it is theoretically possible to balance these hot and cold spots by balancing the amount of coolant used in these regions. This has historically been the approach. In practice, this is extremely difficult, both to know where hot spots occur and accurately meter the flow of the coolant (e.g., propellant) in these regions. Slightly too much flow of coolant, and average temperatures of coolant are decreased, reducing performance. Slightly too little flow and fuel temperatures increase, increasing risk and decreasing operating margin. Historical solutions only produce optimal performance at a single operating point, but the mission occurs over a range of operating points.

Spiral coolant channel geometry 144 can improve the relationship between optimal operation and average operation, increase total mission propellant efficiency, and decrease risk at the same average specific performance. Spiral coolant channel geometry 144 homogenizes the temperature within the fuel element 104 and amongst the fuel elements 104A-N, which improves performance, reliability, and efficiency of the fuel element 104 and nuclear reactor system 100. The spiral coolant channel geometry 144 is a robust and self-balancing solution, which does not require exact knowledge of apriori power distributions.

Additionally, an NTP type of nuclear reactor system 100 typically contains drums 115A-N with neutron poisons for control. Rotation of the control drum 115A-N results in a change in the fuel temperature by changing the spatial distribution of power. However, the control drums 115A-N also perturb the power distribution within the fuel, changing the optimal balance of propellant per coolant channel 141A-N. Traditional methods (orificing) only provide an optimal solution at a single drum angle of the control drums 115A-N.

Spiral coolant channel geometry 144 allows for a radial smearing of power within equiradial rings of coolant channels 141A-N and largely removes an azimuthal dependency on the power level. The spiral coolant channel geometry 144 allows flow and pressure drop to be essentially equal within any coolant channel 141A-N within a given ring.

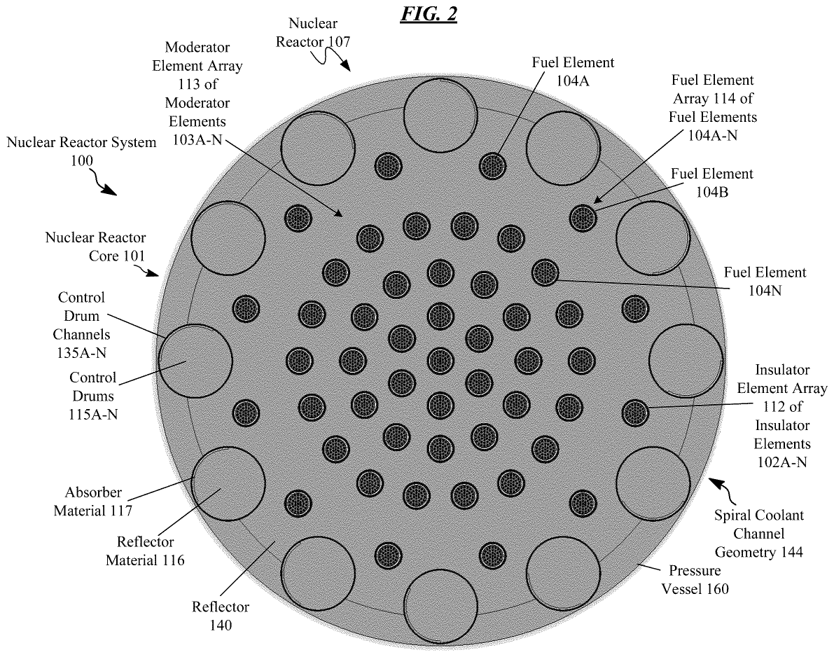

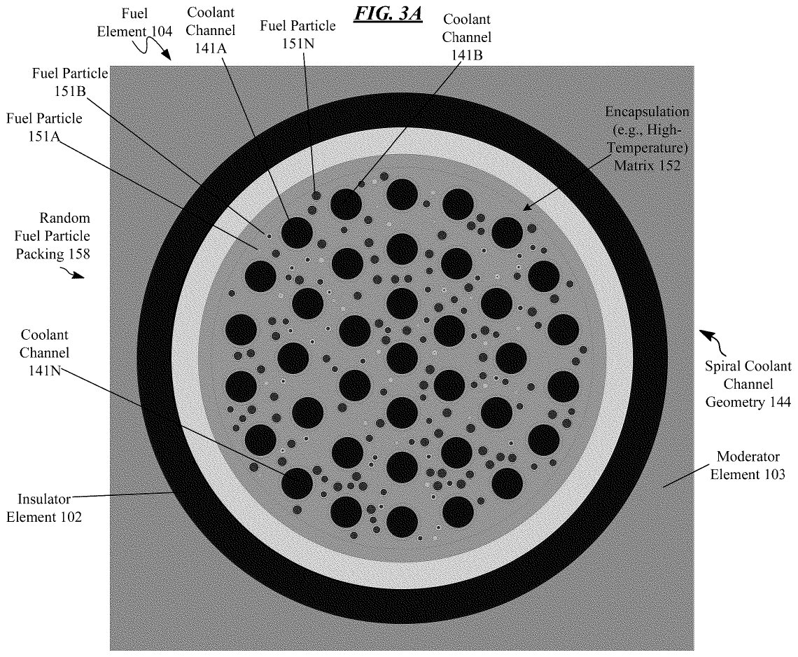

FIGS. 3A-B are zoomed in views of the nuclear reactor core 101 of FIG. 2 showing details of a single fuel element 104 that includes coolant channels 141A-N with the spiral coolant channel geometry 144. FIG. 3A shows a random fuel particle packing 158 and FIG. 3B shows an ordered fuel particle packing 157. As described in FIG. 12, fuel element 104 can be manufactured using a spiral coolant channel fabrication method 1200 that can implement additive manufacturing and additional processing steps.

In total, thirty-seven coolant channels 141A-N per fuel element 104 are shown in FIGS. 2 and 3A-B. However, the number of coolant channels 141A-N can vary depending on the design of the nuclear reactor core 101. Although the coolant channels 141A-N are depicted as cylinders, the coolant channels 141A-N can be formed into a variety of shapes. For example, the coolant channels 141A-N can be oval, square, rectangular, triangular, or another polygon shape.

Fuel element 104 is surrounded by an insulator element 102 which, in turn, is surrounded by a moderator element 103. In FIGS. 3A-B, fuel elements 104A-N are depicted as cylinders, insulator elements 102A-N are depicted as a cylindrical shaped tube or pipe, and the coolant channels 141A-N are depicted as cylinders. However, the fuel elements 104A-N, insulator elements 102A-N, and coolant channels 141A-N can be formed into a variety of shapes. In addition to being a circular or other round shape in two-dimensional space, the fuel elements 104A-N can be oval, square, rectangular, triangular, hexagonal, or another polygon shape. For example, the fuel elements 102A-N can be a polyhedron (e.g., a triangular prism or a cuboid) in three-dimensional space. In order to be disposed around the fuel elements 104A-N, the insulator elements 123A-N can be a shape that conforms to the shape of the fuel elements 104A-N.

As further shown, the fuel element 104 includes a plurality of fuel particles 151A-N. Spiral coolant channel geometry 144 can be used with a variety of arrangements of fuel particles 151A-N, such as a random fuel particle packing 158, an ordered fuel particle packing 157, etc.

As shown in FIGS. 3A and 4A-B, fuel particles 151A-N can be randomly packed to implement a random fuel particle packing 158 in the fuel element 104. Because of the random distribution of the fuel particles 151A-N in the depicted cross-section of FIG. 3A, the fuel particles 151A-N are cut at varying thicknesses. Thus, the fuel particles 151A, 151B, and 151N appear to have varying sizes like a watermelon cut at varying cross-sections in FIG. 3A. Hence, fuel particle 151A appears smaller than fuel particle 151B; and fuel particle 151B appears smaller than fuel particle 151N.

Alternatively, as shown in FIGS. 3B and 5A-B, the fuel particles 151A-N can be packed in an ordered manner to implement an ordered fuel particle packing 157 in the fuel element 104. Ordered fuel particle packing 157 can include a variety of geometries, such as a twisted geometry 156 as depicted FIGS. 5A-B. Thirty-seven fuel particle matrices 111A-N and thirty-seven coolant channels 141A-N per fuel element 104 are shown in FIG. 3B. There is one fuel particle matrix 111A-N associated with each coolant channel 141A-N (one fuel particle matrix 111A-N per coolant channel 141A-N). However, the number of fuel particle matrices 111A-N can vary depending on the design of the nuclear reactor core 101.

Fuel element 104 includes an encapsulation matrix 152 and a plurality of coolant channels 141A-N formed in the encapsulation matrix 152. Fuel particles 151A-N can be disposed within the encapsulation matrix 152. In a first example, the encapsulation matrix 152 includes graphite. In a second example, the encapsulation matrix 152 is a high-temperature matrix. The high-temperature matrix can include silicon carbide, zirconium carbide, titanium carbide, niobium carbide, tungsten, molybdenum, or a combination thereof.

Fuel element 104 includes coolant channels 141A-N formed therein to provide thermal contact between the coolant and the fuel particles 151A-N of FIGS. 3A and 4B; and the fuel particle matrices 111A-N of FIGS. 3B and 5B. In the random fuel particle packing 158 of FIGS. 3A and 4B, the fuel particles 151A-N are spread out more uniformly in the encapsulation matrix 152 and not as concentrated near the coolant channels 141A-N. In the ordered fuel particle packing 157 of FIGS. 3B and 5B, the nuclear fuel in each of the fuel particles 151A-N is moved as close as possible to the coolant channels 141A-N enabling ultra-high temperature reactor applications.

Coolant (e.g., propellant) can be a gas or a liquid, e.g., that transitions from a liquid to a gas state during a burn cycle of the nuclear reactor core 101 for thrust generation in an NTP nuclear reactor system 100. Hydrogen is an example coolant for an NTP nuclear reactor system 100. The coolant that flows through the coolant channels 141A-N can include helium, FLiBe molten salt formed of lithium fluoride (LiF), beryllium fluoride (BeF₂), sodium, He, HeXe, CO₂, neon, or HeN. In an NEP or FSP nuclear reactor 107, a working fluid, such as He, neon, HeXe, CO₂, etc. is circulated.

In the example of FIGS. 3A-B, the fuel particles 151A-N are coated fuel particles, such as tristructural-isotropic (TRISO) fuel particles. Alternatively or additionally, the fuel particles 151A-N can include bistructural-isotropic (BISO) fuel particles. In yet another implementation, the fuel particles 151A-N are comprised of a variation of TRISO known as TRIZO fuel particles. A TRIZO fuel particle replaces the silicon carbide layers of the TRISO fuel particle with zirconium carbide (ZrC). Alternatively, the TRIZO fuel particle includes the typical coatings of a TRISO fuel particle and an additional thin ZrC layer coating around the fuel kernel, which is then surrounded by the typical coatings of the TRISO fuel particle.

TRISO-like coatings may be simplified or eliminated depending on safety implications and manufacturing feasibility. Although the fuel particles 151A-N in the example include coated fuel particles, such as TRISO fuel particles, BISO fuel particles, or TRIZO fuel particles, the fuel particles 151A-N can include uncoated fuel particles.

Each of the TRISO fuel particles 151A-N can include a fuel kernel surrounded by a porous carbon buffer layer, an inner pyrolytic carbon layer, a binary carbide layer (e.g., ceramic layer of SiC or a refractory metal carbide layer), and an outer pyrolytic carbon layer. The refractory metal carbide layer of the TRISO fuel particles 151A-N can include at least one of titanium carbide (TiC), zirconium carbide (ZrC), niobium carbide (NbC), tantalum carbide, hafnium carbide, ZrC—ZrB₂ composite, ZrC—ZrB₂—SiC composite, or a combination thereof. The encapsulation matrix 152 can be formed of the same material as the binary carbide layer of the TRISO fuel particles 151A-N.

TRISO fuel particles 151A-N are designed not to crack due to the stresses or fission gas pressure at temperatures beyond 1,600° C., and therefore can contain the nuclear fuel within in the worst of accident scenarios. TRISO fuel particles 151A-N are designed for use in high-temperature gas-cooled reactors (HTGR) and to be operating at temperatures much higher than the temperatures of light water reactors. TRISO fuel particles 151A-N have extremely low failure below 1,500° C. Moreover, the presence of the encapsulation matrix 152 provides an additional robust barrier to radioactive product release.

A description of TRISO fuel particles dispersed in a silicon carbide matrix to form a cylindrical shaped nuclear fuel compact is provided in the following patents and publications of Ultra Safe Nuclear Corporation of Seattle, Washington: U.S. Pat. No. 9,299,464, issued Mar. 29, 2016, titled “Fully Ceramic Nuclear Fuel and Related Methods”; U.S. Pat. No. 10,032,528, issued Jul. 24, 2018, titled “Fully Ceramic Micro-encapsulated (FCM) fuel for CANDUs and Other Reactors”; U.S. Pat. No. 10,109,378, issued Oct. 23, 2018, titled “Method for Fabrication of Fully Ceramic Microencapsulation Nuclear Fuel”; U.S. Pat. No. 9,620,248, issued Apr. 11, 2017 and U.S. Pat. No. 10,475,543, issued Nov. 12, 2019, titled “Dispersion Ceramic Micro-encapsulated (DCM) Nuclear Fuel and Related Methods”; U.S. Pat. No. 11,264,141, issued Mar. 1, 2022, titled “Composite Moderator for Nuclear Reactor Systems”; and U.S. Pat. No. 10,573,416, issued Feb. 25, 2020, titled “Nuclear Fuel Particle Having a Pressure Vessel Comprising Layers of Pyrolytic Graphite and Silicon Carbide,” the entireties of which are incorporated by reference herein. As described in those Ultra Safe Nuclear Corporation patents, the nuclear fuel can include a cylindrical fuel compact or pellet comprised of TRISO fuel particles embedded inside a silicon carbide matrix to create a cylindrical shaped nuclear fuel compact. A description of TRISO, BISO, or TRIZO fuel particles dispersed in a zirconium carbide matrix to form a cylindrical shaped nuclear fuel compact is provided in U.S. Pat. No. 11,189,383, to Ultra Safe Nuclear Corporation of Seattle, Washington, issued Nov. 30, 2021, titled “Processing Ultra High Temperature Zirconium Carbide Microencapsulated Nuclear Fuel,” the entirety of which is incorporated by reference herein.

The fuel particles 151A-N are formed of an internal fuel kernel, and at least one coating layer. The fuel kernel can be formed of uranium carbide (UCₓ), thorium dioxide (ThO₂), uranium oxides (e.g., UO₂, UCO, Stabilized UO₂), uranium mononitride (UN), uranium—molybdenum (UMo) alloy, uranium—zirconium (UZr) alloy, triuranium disilicate (U₃Si_{2,5}), uranium boride (UB), uranium diboroide (UB₂), uranium gadolinium carbide nitride (UGdCN), uranium zirconium carbide nitride (UZrCN), uranium zirconium carbide (UZrC), uranium tricarbide (UC₃), uranium zirconium niobium carbide (UZrNbC), molten fuel in a carbon kernel (i.e., infiltrated kernel), composites (e.g., uranium-dioxide-molybdenum (UO₂Mo) alloy, uranium nitride/triuranium disilicate (UN/U₃Si₂), or triuranium disilicate/uranium diboride (U₃Si₂/UB₂)), dopants (e.g. chromium oxide (Cr₂O₃)), other fissile and fertile fuels, or any combination thereof. The kernel can be spherical, a composite, or formed of nanofibers. The at least one coating layer of the fuel particles 151A-N may be formed of pyridine carbide (PyC), silicon carbide (SiC), zirconium carbide (ZrC), zirconium diboride (ZrB₂), niobium carbide (NbC), titanium carbide (TiC), tantalum carbide (TaC), titanium nitride (TiN), boron carbide (B₄C), beta-decayed silicon nitride (β-Si₃N₄), SiAlON ceramics, or any combination thereof.

In a more specific example, each of the fuel particles 151A-N can include a porous carbon buffer layer surrounding the internal kernel, an inner pyrolytic carbon layer, a binary carbide layer (e.g., ceramic layer of SiC or a refractory metal carbide layer), and an outer pyrolytic carbon layer. The refractory metal carbide layer of the fuel particles 151A-N can include at least one of titanium carbide (TiC), zirconium carbide (ZrC), niobium carbide (NbC), tantalum carbide, hafnium carbide, ZrC—ZrB₂ composite, ZrC—ZrB₂—SiC composite, or a combination thereof. The other layers of the fuel particles 151A-N can be formed of the same material as the at least one coating layer mentioned above.

Fuel particles 151A-N of the fuel element 104 can be similar in size or of substantially the same size. Alternatively, the fuel particles 151A-N can be of varying particle sizes to improve a packing fraction in the fuel element 104. In some examples, the fuel particles 151A-N can be between approximately 100 and 2,000 microns, with multiple size populations (e.g., 100 microns, 700 microns, 2,000 microns, etc.) to enhance the packing fraction of fuel particles 151A-N.

High-temperature matrix 152 may be formed of silicon carbide (SiC), which has excellent chemical stability in the presence of air and water in repository conditions, but also at temperatures of a nuclear reactor core 101. If SiC is not sufficiently high performance, another high-temperature matrix 152 material such as zirconium carbide (ZrC) can also be used. Some examples of high-temperature matrix 152 materials include silicon carbide (SiC), zirconium carbide (ZrC), magnesium oxide (MgO), tungsten (W), molybdenum (Mo), zirconium boride (ZrB₂), NbC, TiC, TaC, TiN, zirconium (Zr), TaC, B₄C, β-Si₃N₄, SiAlON ceramics, aluminum nitride (AlN), aluminum oxide (Al₂O₃), stainless steel, or any combination thereof.

FIG. 4A is a cutaway view of a single fuel element 104 similar to that of FIG. 3A that depicts the spiral coolant channel geometry 144 and the random fuel particle packing 158. In FIG. 4A, the fuel element 104 includes fourteen coolant channels 141A-N. However, the precise number can vary depending on the nuclear reactor core 101. Also shown in FIG. 4A is an encircled detail area to show context for a zoomed in view of FIG. 4B.

FIG. 4B is the zoomed in view of the encircled detail area of the fuel element 104 of FIG. 4A with the fuel particles 151A-N arranged in the random fuel particle packing 158. As shown in FIGS. 4A-B, the spiral coolant channel geometry 144 can be used with unordered fuel particles 151A-N. For example, the fuel particles 151A-N can be randomly packed. In FIG. 4B, fuel particle 151A is in the distance of the zoomed in view and thus appears smaller than fuel particle 151B. Fuel particle 151N is the nearest and thus appears the largest in the zoomed in view.

FIG. 5A is a cutaway view of a single fuel element 104 similar to that of FIG. 3B that depicts the spiral coolant channel geometry 144 and the ordered fuel particle packing 157. In FIG. 5A, the fuel element 104 includes fourteen fuel particle matrices 111A-N and fourteen coolant channels 141A-N. However, the precise number can vary depending on the nuclear reactor core 101. Also shown in FIG. 5A is an encircled detail area to show context for a zoomed in view of FIG. 5B. Fuel element 104 includes 104 fuel particle matrix 111N with the ordered fuel particle packing 157 in a twisted geometry 156.

FIG. 5B is the zoomed in view of the encircled detail area of the fuel element 104 of FIG. 5A with the fuel particles 151A-N arranged in the ordered fuel particle packing 157. As shown in FIGS. 5A-B, fuel particle matrix 111N is ordered in the twisted geometry 156. Each of the fuel particle matrices 111A-N can be in the twisted geometry 156. To accommodate the fuel particle matrices 111A-N in the twisted geometry 156, the coolant channels 141A-N have a helical shape 153. Each of the plurality of fuel particles 151A-N helically wind around the respective coolant channel 141A-N. Hence, each of the fuel particle matrices 111A-N spirals around the respective coolant channel 141A-N.

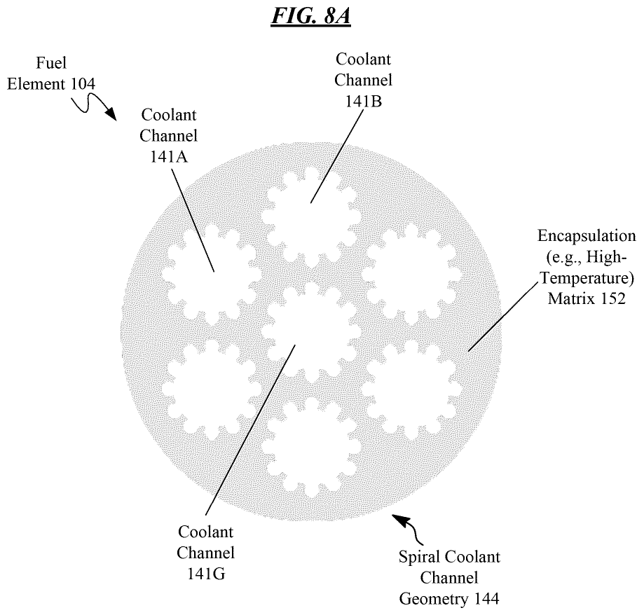

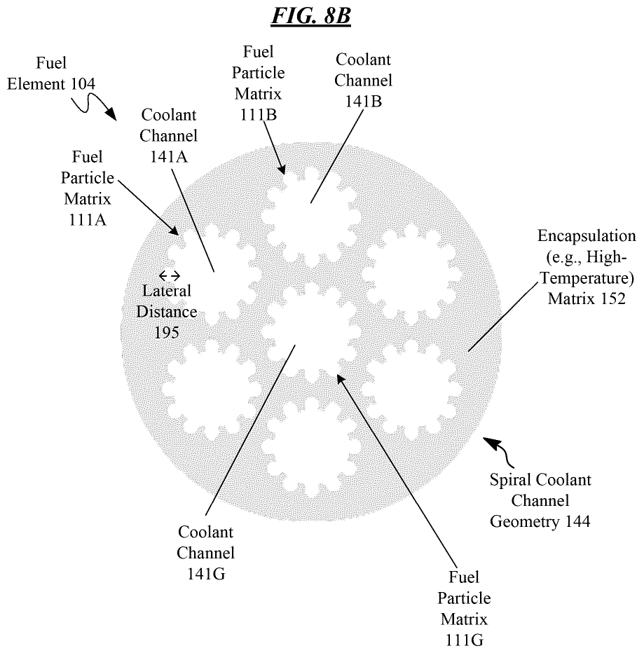

Referring to FIGS. 5A-B, the fuel element 104 implements the spiral coolant geometry 144 and the ordered fuel particle packing 157. Each of the fuel particle matrices 111A-N can be ordered in a twisted geometry 156 to: (a) substantially laterally surround a contour of a respective coolant channel 141A-N, and (b) orient substantially helically along the respective coolant channel 141A-N. In the example of FIGS. 3B and 5A-B, each of the fuel particle matrices 111A-N can be formed as a ring shape (e.g., annulus) to follow the contour (e.g., outline, periphery shape, profile, etc.) of the respective coolant channel 141A-N. Although a single ring is shown in FIG. 3B, the fuel particle matrices 111A-N can be formed as a multiple ring arrangement of fuel particles 151A-N, such as a double ring arrangement or other laterally nested geometry 197 (see FIG. 8C).

Each of the fuel particle matrices 111A-N includes a plurality of fuel particles 151A-N that are a cluster 181 around the respective coolant channel 141A-N. The plurality of fuel particles 151A-N can spiral around the respective coolant channel 141A-N.

Because the fuel particle matrices 111A-N substantially laterally surround a contour of a respective coolant channel 141A-N, the fuel particle matrices 111A-N can mimic a periphery shape of the respective coolant channel 141A-N. Hence, the fuel particle matrices 111A-N can also be formed in a variety of shapes or patterns. For example, the fuel particle matrices 111A-N can be ring shaped (e.g., annularly arranged) as shown in FIG. 3B; or oval, square, rectangular, triangular, or another polygon shape that can depend on the contour of the respective coolant channel 141A-N.

Fuel element 104 can implement the ordered fuel particle packing 157 to provide material barriers to the transport of fission products and fissile materials. The fuel element 104 is arranged in a manner to ensure that each discrete element of fuel (fuel particles 151A-N) is maintained at a constant, predictable, and minimum distance from the coolant (e.g., propellant). Different temperature profiles can create differential thermal stresses in a nuclear reactor core 101, which can result in material cracks. However, the ordered fuel particle packing 157 can prevent the material cracks from transmitting from the fuel material through surface walls.

The precise dimensions and arrangement of the ordered fuel particle packing 157 around the coolant channels 141A-N (e.g., heat transfer pipes) can be variable to achieve criticality for a given nuclear design goal and design of the nuclear reactor 107. The annular placement of the fuel particle matrices 111A-N around the coolant channels 141A-N or propellant flow surface can be designed to minimize the thermal gradient between the nuclear fuel in the fuel particles 151A-N by minimizing the heat transfer resistance between the center of the nuclear fuel to achieve criticality for the given design criteria. Ordered fuel particle packing 157 allows the nuclear fuel to operate as close as possible to the maximum possible temperature it can survive during normal operation, enabling ultra-high temperature reactor applications of the nuclear reactor 107.

In FIGS. 5A-B, each of the plurality of fuel particles 151A-N can be substantially uniform in population number 182. For example, each of the plurality of fuel particles 151A-N are substantially uniform in population density 183 in the cluster 181 around the respective coolant channel 141A-N. The fuel particles 151A-N of each fuel particle matrix 111A-N may appear non-uniformly distributed on a microscopic scale. But when aggregated as a whole and viewed on a macroscopic scale, the aggregation of the plurality of fuel particles 151A-N of each fuel particle matrix 111A-N is perceived as being packed in an ordered manner to an observer. Hence, the fuel element 104 has an ordered fuel particle packing 157.

FIG. 6 is an isometric view of a single fuel element 104 similar to that of FIGS. 4A-B and 5A-B and showing details of the coolant channels 141A-N helically winding around a longitudinal axis 145. Fuel element 104 includes the plurality of coolant channels 141A-N formed therein with a helical shape 153. As shown in FIG. 6 (see also FIGS. 4A and 5A), each of the coolant channels 141A-N rotate around the longitudinal axis 145 of the fuel element 104 such that a lateral position 147A-N of a respective coolant channel 141A-N on a lateral axis 146 changes at different longitudinal levels (e.g., axial positions) 192A-N along the longitudinal axis 145 of the fuel element 104. As further shown in FIG. 6 (see also FIGS. 4A and 5A), the respective coolant channel 141A-N substantially helically winds around the longitudinal axis 145. The changing lateral position 147A-N of the respective coolant channel 141A-N forms at least one twist 148 along the longitudinal axis 145.

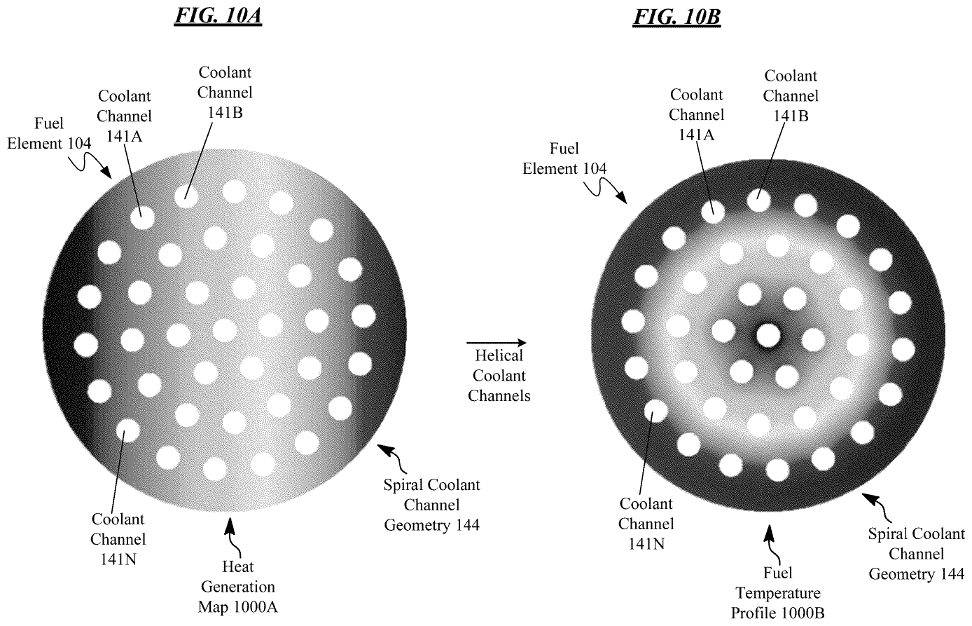

As shown in FIGS. 10A-B and 11, the at least one twist 148 is configured to smear a thermal profile of the fuel element 104 to balance power distribution within the fuel element 104. The at least one twist 148 is configured to spiral a flow of a coolant or a propellant through the fuel element 104 to temperature balance hot and cold spots in a nuclear reactor core 101. The twist 148 significantly reduces the challenge of asymmetric heat generation in highly peaked fuel elements 104A-N, such as those near control drums 115A-N.

Spiral coolant channel geometry 144 can interlace the coolant channels 141A-N to homogenize the fuel temperature intra radially (e.g., from outer locations to inner locations or radially) as well as inter radially (within a given radial ring). For example, the coolant channels 141A-N can be in a braid configuration. Hence, the spiral coolant channel geometry 144 can implement many different patterns.

Like FIGS. 2 and 3A-B, in total, thirty-seven coolant channels 141A-N per fuel element 104 are shown in FIG. 6. However, the number of coolant channels 141A-N can vary depending on the implementation of the fuel element 104. For example, if the fuel element 104 implements the ordered fuel particle packing 157, the number of coolant channels 141A-N can vary depending on the number of fuel particle matrices 111A-N.

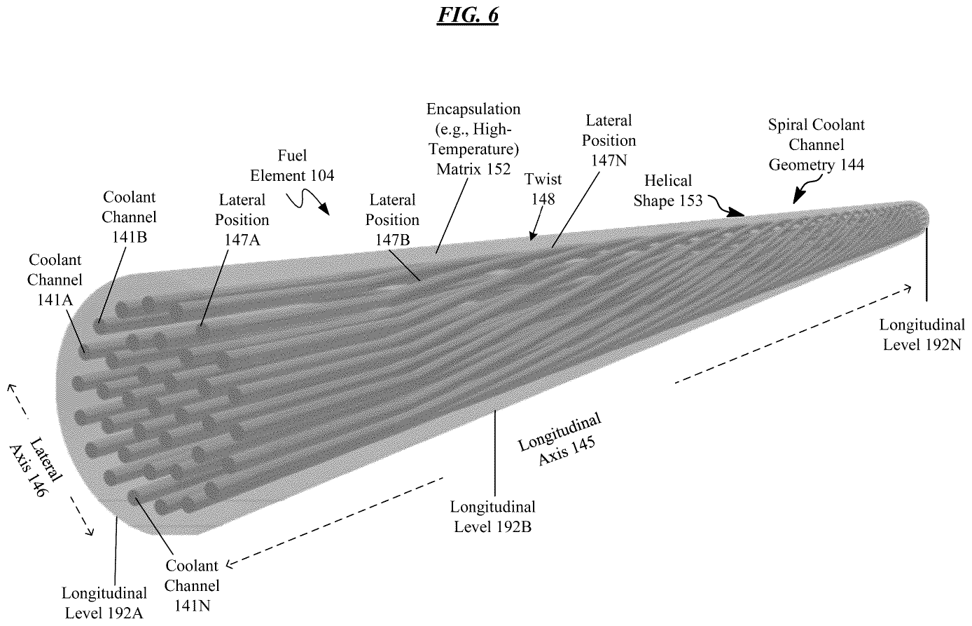

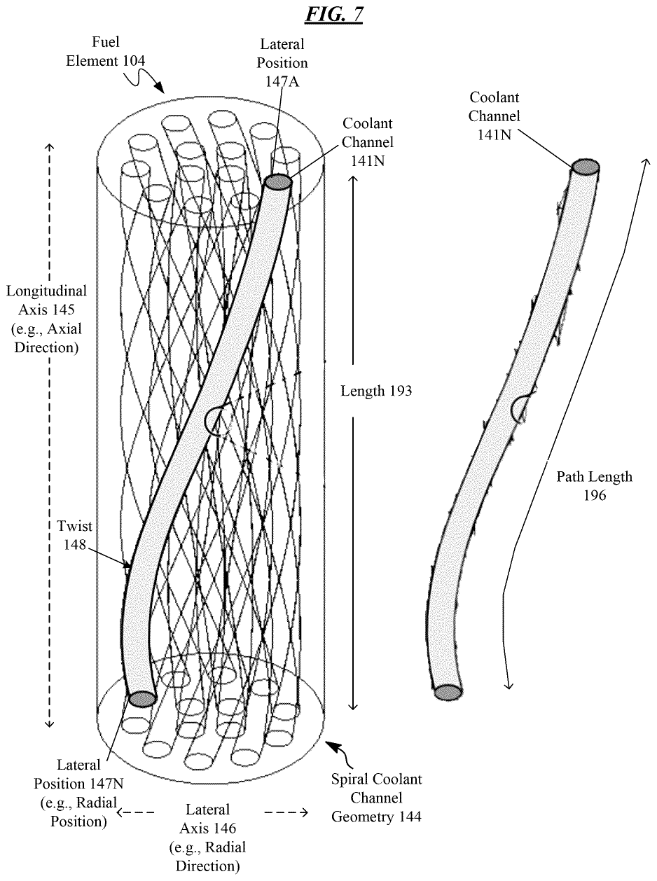

FIG. 7 compares a path length 196 of a coolant channel 141N with a length (e.g., height) 193 of a fuel element 104 that implements the spiral coolant channel geometry 144. As shown in FIG. 7, the path length 196 of the respective coolant channel 141N exceeds the length 193 of the fuel element 104. By forming the coolant channels 141A-N as openings with a substantially helical shape (as opposed to vertical openings with a straight shape), the surface area of the coolant channels 141A-N is increased. Heat can be more evenly distributed between the center and periphery of the fuel element 104 as the coolant channels 141A-N form a twist 148 along the longitudinal axis 145 of the fuel element 104.

Spiral coolant channel geometry 144 of the coolant channels 141A-N provides greater surface area (effectively the tube is longer). As the coolant (e.g., propellant) moves through the fuel element 104, a respective coolant channel 141A-N distributes the heat throughout to increase average temperature of the coolant and minimizes hot and cold spots in the fuel elements 104A-N of the nuclear reactor core 101. Spiral coolant channel geometry 144 does not need to be used with the ordered particle packing 157. With the unordered fuel particles 151A-N, such as in the random fuel particle packing 158, the temperature of the fuel element 104 is still improved laterally (e.g., radially) by more evenly distributing heat within the inner and outer parts of the fuel element 104.

Spiral coolant channel geometry 144 can include individual coolant channels 141A-N with centerlines at different lateral positions 147A-N (e.g., cylindrical coordinates (r, theta) on the lateral axis 146 at different longitudinal levels 192A-N (e.g., axial positions (z)) on the longitudinal axis 145. The different centerlines can enable the coolant to distribute heat through the fuel element 104 and improve uniformity. This effect has a much greater impact than the thermal conductivity in the radial direction on flow and power balancing.

The axial gradient in power flux through a nuclear reactor 107 is generally of a lower magnitude than the radial (r, theta) gradient. If the coolant channel 141N has the same constant lateral position 147N (e.g., radial position) as it extends through the axial length of the nuclear reactor core 101, then higher power (due to radial peaking) at the inlet of the coolant channel 141A-N causes the temperature of the coolant channel 141N to increase. As the flow moves axially through the nuclear reactor core 101, the same radial peaking factor is intersected, resulting in more power being added to the hotter coolant channel 141N, which results essentially in a feedback loop.

If the lateral position 147A-N (e.g., radial position) of the coolant channel 141N changes as it moves along the longitudinal axis 145 (e.g., axial direction), such as axially through the nuclear reactor core 101, the coolant channel 141N intersects different radial power factors. If the coolant channel 141N goes through a hot spot, then later the coolant channel 141N will go through a cold spot. Hence, spiral coolant channel geometry 144 can include a wide range of spiral, twisting, and helical paths to optimally balance the power distribution of the fuel element 104.

One possible disadvantage of the use of the spiral coolant channel geometry 144 is that it can impart a non-negligible angular momentum to the propellant, which can cause the flow to be non-linear. If not mitigated, this may cause the propulsive thrust to include an angular momentum term in addition to an axial momentum term, which would tend to cause a vehicle to spin. This may be undesirable for a number of reasons. However, there are two methods to resolve this issue. First is the use of an equal number of opposite hand fuel elements 104A-N that are counter-rotating, so that an equal amount of clockwise and counter-clockwise momentum is added to the propellant. Alternatively, a flow straightener at the outlet of the fuel element 104 can allow the momentum to be canceled out within the structure of the fuel element 104 and cause the propellant to leave with net zero angular momentum. Additionally, the angular momentum (whether canceled out within the fuel element 104 or the nuclear reactor 107) may require additional pressure energy to be contained within the propellant, imparted by either an increase in pump discharge pressure or tank pressure. However, this has a negligible impact on overall performance of the nuclear reactor system 100 and is more than counteracted by the net increase in performance from the azimuthal smearing (e.g., lateral or radial smearing) of the power distribution in the nuclear reactor system 100.

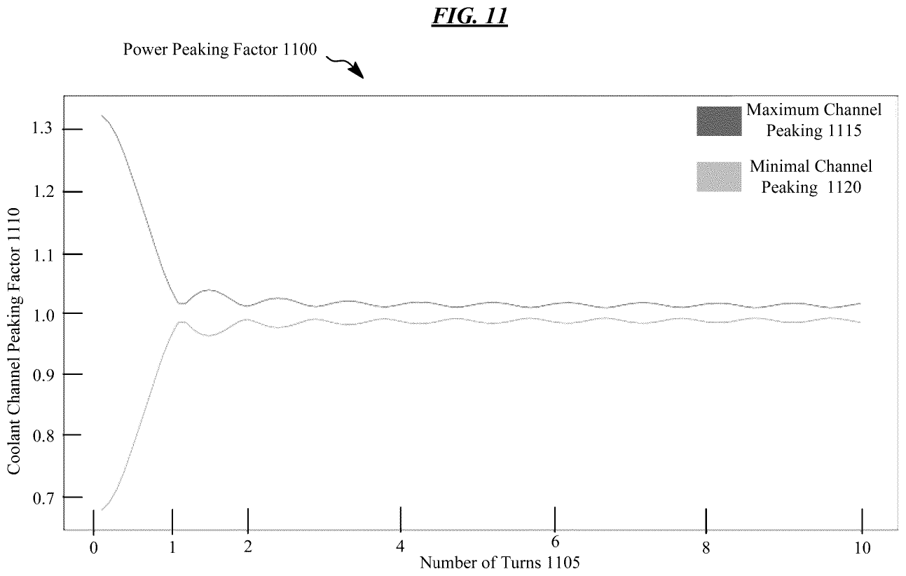

As described in FIG. 11, an unexpected result is that there is negligible difference within a given coolant channel 141N no matter where the coolant channel 141N starts and stops as long as there is roughly one rotation (e.g., turn or twist 148). The rotation is like a sweep of the coolant channel 141N through the asymmetric thermal field to balance cold and hot spots. More rotations provide greater homogenization at an increased pressure drop and increased angular momentum applied to the fuel element 104. Depending on the application, the nuclear reactor system 100 can include a flow straightener or implement counter-rotating fuel elements 104A-N to counteract this angular momentum.

FIG. 8A is a cross-sectional view of a single fuel element 104 similar to that of FIGS. 4A-B showing details of coolant channels 141A-G. In FIG. 8A, the fuel element 104 includes seven coolant channels 141A-G. However, the precise number can vary depending on the nuclear reactor core 101. Coolant channels 141A-N are openings, passages, apertures, or holes to allow the coolant to pass through the fuel element 104 and into a thrust chamber (not shown) for propulsion, for example.

FIG. 8B is a cross-sectional view of a single fuel element 104 similar to that of FIGS. 5A-B showing details of coolant channels 141A-G and fuel particle matrices 111A-G. In FIG. 8B, the fuel element 104 includes seven fuel particle matrices 111A-G and seven coolant channels 141A-G. However, the precise number can vary depending on the nuclear reactor core 101.

In the ordered fuel particle packing 157, each of the fuel particles 151A-N of the fuel particle matrix 111A can be at approximately the same lateral distance 195 to the coolant channel 141A. Moreover, each of the fuel particle matrices 111A-N can be at approximately the same lateral distance 195 to the respective coolant channel 141A-N. These configurations optimize heat transfer by minimizing the transport distance of heat generated to the coolant to improve lifetime and fission product retention. For example, the twisted geometry 156 of FIGS. 5A-B can implement such configurations.

FIG. 8C is a cross-sectional view of a fuel element 104 like that of FIGS. 5A-B with an ordered fuel particle packing 157 in which the fuel particle matrix 111A has a laterally nested geometry 197. In the example of FIG. 8C, the plurality of fuel particles 151A-N of the fuel particle matrix 111A form the laterally nested geometry 197, which is a double ring. However, the laterally nested geometry 197 can be three or more rings, or other shape, such as a polygon, oval, etc. that follows the contour of the coolant channel 141A. In FIG. 8C, the fuel element 104 also includes an ablation layer 198 that is located between the coolant channel 141A and the fuel particle matrix 111A. Ablation layer 198 provides ablation and thermal resistance and can be formed of any suitable material, such as HfCZrN, for example. Fuel particles 151A-N can be in good thermal contact with the ablation layer 198. A thickness of the ablation layer 198 can vary according to an axial ablation rate and nucleotide retention needs of the nuclear reactor core 101.

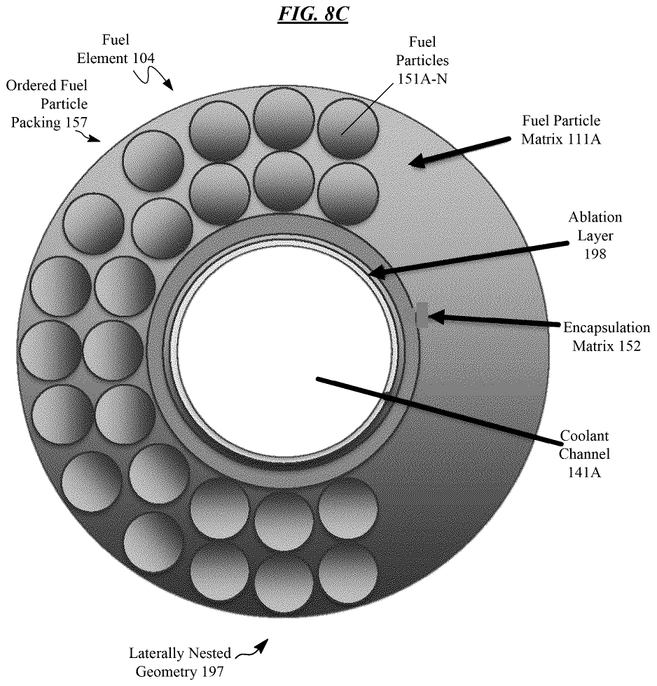

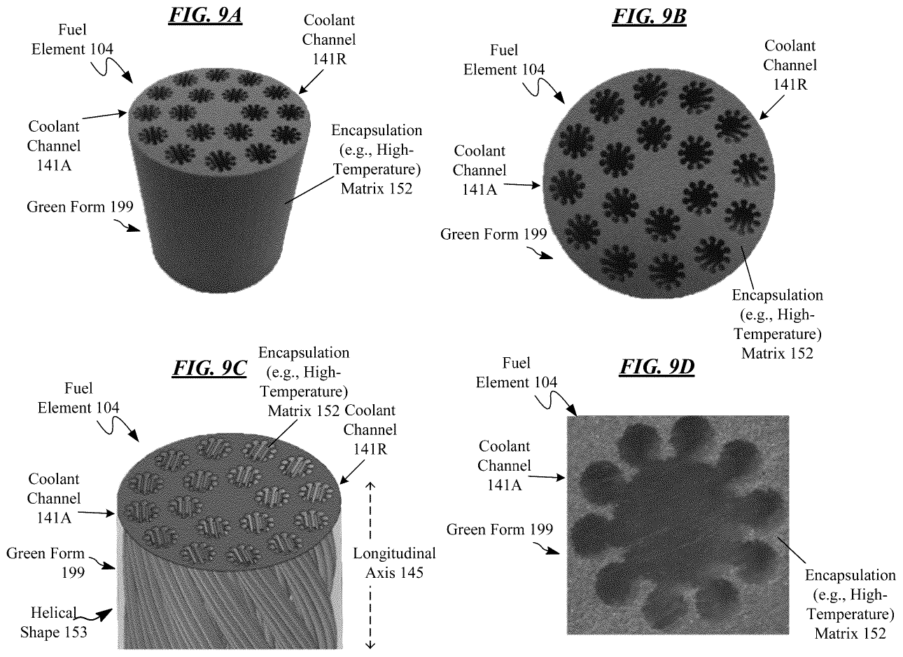

FIG. 9A is an isometric view of a green form (e.g., green body) 199 of a single fuel element 104 that includes coolant channels 141A-R. FIG. 9B is a top view of the green form 199 of FIG. 9A showing details of the coolant channels 141A-R. FIG. 9C is a cutaway view of the green form 199 of FIGS. 9A-B showing details of the green form 199 and the coolant channels 141A-N formed therein with a helical shape 153. In FIGS. 9A-C, the fuel element 104 includes eighteen coolant channels 141A-R. If the fuel element 104 includes the ordered fuel particle packing 157, then the fuel element 104 can include eighteen fuel particle matrices 111A-R. FIG. 9D is a top view of a single coolant channel 141A of the green form 199 of FIGS. 9A-C.

As shown in FIG. 9C, coolant channels 141A-N formed in the encapsulation matrix 152 of the green form 199 can be helical shaped openings. The helical shape 153 of the coolant channels 141A-N can wind around the longitudinal axis 145 of the fuel element 104, which can accommodate fuel particles 151A-N arranged in the random fuel particle packing 158 (see FIGS. 4A-B). Alternatively, the helical shape 153 of the coolant channels 141A-N can accommodate fuel particle matrices 111A-N arranged in the ordered fuel particle packing 157, such as the twisted geometry 156 (see FIGS. 5A-B).

FIG. 10A is a diagram of a heat generation map for a fuel element 104 with a spiral coolant channel geometry 144. FIG. 10B is a diagram of a fuel temperature profile 1000B for the fuel element 104 of FIG. 10A with the spiral coolant channel geometry 144. Despite the asymmetric heat deposition shown in the heat generation map 1000A, the spiral coolant channel geometry 144 produces a substantially uniform circumferential temperature distribution as shown in the fuel temperature profile 1000B. The radial in-fuel element temperature gradients can be even further improved by orificing each radial ring of coolant channels 141A-N.

Failure in a nuclear reactor system 100, such as an NTP system, can be caused by high peak temperatures and the distribution of peak temperatures. In addition, challenges in accurately measuring and modeling peak temperatures can cause failure. The spiral coolant channel geometry 144 can thermally flatten peak temperatures, thereby reducing power peaking, and reduces thermal stresses in the fuel element 104. Spiral coolant channel geometry 144 also significantly reduces the thermal kinetics of the fuel rod leading to a more robust NTP system. By homogenizing the temperatures in the fuel element 104, the bending thermal stresses from the implied pseudo-spherical thermal profile are removed and the fuel element 104 can mostly be in hoop stress, which simplifies further thermal stress accommodation methods.

FIG. 11 is diagram of a power peaking factor 1100 for a fuel element 104 with the spiral coolant channel geometry 144. The power peaking factor 1100 is a highest local power density at a hottest portion of the fuel element 104 divided by an average power density of the fuel element 104. The hottest portion of the fuel element 104 is co-located with the highest local power density. The temperature difference between the hottest portion of the fuel element 104 and the average of the fuel element 104 is proportional to the power peaking factor. Because the average power density of the fuel element 104 is limited by the ability of a material in the hottest portion of the fuel element 104 with the highest local power density, a high power peaking factor is a barrier to performance and reliability of the fuel element 104 and thus the nuclear reactor core 101.

The X axis plots number of turns 1105, such as twist(s) 148, in the coolant channels 141A-N and the Y axis plots the resulting coolant channel peaking factor 1110. Two lines are plotted—a maximum channel peaking 1115 and a minimal channel peaking 1120. As shown, when the number of turns 1105 equals one, such as a single twist 148 in the coolant channels 141A-N, brings the coolant channel peaking factor 1110 down to approximately 1.0.

The unexpected result shown in FIG. 11 is the magnitude of radial temperature homogenization from just a single turn (e.g., a single twist 148) over the entire length 193 of the fuel element 104. Gains after 1.5 turns (e.g., twist(s) 148) are negligible. While a small number of turns 1105 (e.g., 1.5 turns) is sufficient to homogenize temperature of the coolant (e.g., propellant), a higher number of turns 1105 can enable better homogenization of wall/structure temperatures in the fuel element 104.

Hence, the spiral coolant channel geometry 144 of the fuel element 104 can simplify one of the most challenging aspects of NTP fuel design, namely power peaking variation between channels. The unique geometric features of the spiral coolant channel geometry 144 essentially smear the thermal profile of the fuel laterally (e.g., azimuthally) to generate an axisymmetric temperature at all longitudinal levels 192A-N (e.g., axial positions/locations) in the fuel element 104, regardless of the presence of sharp power gradients, such as near control drums 115A-N or boundaries.

Spiral coolant channel geometry 144 enables an increase in propulsive efficiency of nuclear thermal reactor engines at lower temperatures. In addition, spiral coolant channel geometry 144 also significantly simplifies the challenge of balancing flow and power distributions within fuel elements 104A-N. Spiral coolant channel geometry 144 is also applicable to a wide range of extreme high temperature reactor applications.

FIG. 12 is a flowchart of a spiral coolant channel fabrication method 1200 for a fuel element 104. Spiral coolant channel fabrication method 1200 can be used to form the fuel element 104 with a spiral coolant channel geometry 144. Fuel particles 151A-N can be ordered in a random fuel particle packing 158 (see FIGS. 3A and 4A-B) or arranged in an ordered fuel particle packing 157 (see FIGS. 3B and 5A-B).

Generally, the manufacturing process for the fuel element 104 can comprise several steps and different technologies including additive manufacturing, chemical vapor infiltration (CVI), chemical vapor deposition (CVD), and fuel particles 151A-N (e.g., particle-based nuclear fuel). A green body 199 of the fuel element 104 (see FIGS. 9A-D) typically undergoes a CVI step 1215 after the printing step 1205, which solidifies green body 199 so that the green body 199 may serve as the primary structure to support the fuel particles 151A-N. The green body 199 can be made of the encapsulation matrix 152, such as a ceramic material capable of withstanding very high temperatures without failure. Placement of the fuel particles 151A-N in the fuel element 104 (step 1210) occurs during one of the four following stages: (1) while the green body 199 is being printed (step 1205); (2) after the green body 199 has been printed but before the CVI step 1215; (3) after an initial partial-CVI step 1215, but before completion of the CVI step 1215, or (4) after completion of the CVI step 1215.

Beginning in step 1205, the spiral coolant channel fabrication method 1200 includes three-dimensional printing a green body 199 (see FIGS. 9A-D) of the fuel element 104 to form at least one twist 148 in the plurality of coolant channels 141A-N. This initial step 1205 uses additive manufacturing to print the green body 199 of the fuel element 104. For example, additive manufacturing can use binder jet printing for ceramics, laser-based system manufacturing for metals and ceramics, etc. As outlined below, additional processing steps and inclusion of fuel particles 151A-N are applied prior to completion.

Although three-dimensional printing (step 1205) opens up many options, the spiral coolant channel geometry 144 can be achieved through more traditional manufacturing techniques. For example, an extruding step can form segmented, angled coolant channels 141A-N that curve (e.g., with a large radius of curvature). There are a number of other process routes that could fabricate such shapes. For example, the extruding step can be used to form the at least one twist 148 in the plurality of coolant channels 141A-N. Pipe bending followed by carburization can also be used, for example, to form the ablation layer 198 (see FIG. 8C).

Continuing to step 1210, the spiral coolant channel fabrication method 1200 further includes placing a plurality of fuel particles 151A-N in selected locations in the fuel element 104. Generally, the step 1210 of placing the plurality of fuel particles 151A-N in the fuel element 104 includes adding the plurality of fuel particles 151A-N to the fuel element 104 during or after the step 1205 of three-dimensional printing the green body 199 of the fuel element 104. However, the plurality of fuel particles 151A-N can be added at more stages as discussed in step 1210 below.

The step 1210 of placing the plurality of fuel particles 151A-N in the fuel element 104 can include depositing each of the plurality of fuel particles 151A-N around the respective coolant channel 141A-N for a random fuel particle packing 158 or an ordered fuel particle packing 157. In the ordered fuel particle packing 157 example, the step of depositing each of the plurality of fuel particles 151A-N can include loading the plurality of fuel particles 151A-N of each of the fuel particle matrices 111A-N around the respective coolant channel 141A-N in the twisted geometry 156 shown in FIGS. 5A-B.

Moving to step 1215, the spiral coolant channel fabrication method 1200 further includes performing chemical vapor infiltration (CVI) to solidify the fuel element 104. The step 1210 of placing the plurality of fuel particles 151A-N in the fuel element 104 includes adding the plurality of fuel particles 151A-N to the fuel element 104: (1) during the step 1205 of three-dimensional printing the green body 199 of the fuel element 104; (2) after the step 1205 of three-dimensional printing the green body 199 of the fuel element 104; (3) after partial completion of the step 1215 of performing chemical vapor infiltration; (4) after completion of the step 1215 of performing chemical vapor infiltration; or (5) a combination thereof.

Depending on the requirements for the fuel element 104, additional steps may be implemented prior to completion. These optional steps include steps 1220 and 1225. Proceeding to optional step 1220, the spiral coolant channel fabrication method 1200 further includes performing chemical vapor deposition (CVD) to bond additional material for the encapsulation matrix 152 to the plurality of fuel particles 151A-N. The additional material for the encapsulation matrix 152 bonds to the fuel particles 151A-N and the fuel element 104 to provide additional protection to the fuel particles 151A-N against chemical or mechanical degradation. Alternatively or additionally, bonding techniques, threaded caps, etc. can deposit the additional material for the encapsulation matrix 152 to form a seal.

Finishing now in optional step 1225, the spiral coolant channel fabrication method 1200 further includes joining the fuel element 104 to other fuel elements 104B-N to form larger or longer fuel elements. Hence, after completion, an individual fuel element 104 may be joined to form larger or longer fuel elements as needed for the selected use of the fuel.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,”“having,” “containing,”“contain,” “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A fuel element, comprising:
a plurality of coolant channels formed therein, wherein each of the coolant channels rotate around a longitudinal axis of the fuel element such that a lateral position of a respective coolant channel changes at different longitudinal levels along the longitudinal axis.

2. The fuel element of claim 1, wherein:
the respective coolant channel substantially helically winds around the longitudinal axis.

3. The fuel element of claim 1, wherein:
the changing lateral position of the respective coolant channel forms at least one twist along the longitudinal axis.

4. The fuel element of claim 3, wherein:
the at least one twist is configured to smear a thermal profile of the fuel element to balance power distribution within the fuel element.

5. The fuel element of claim 3, wherein:
the at least one twist is configured to spiral a flow of a coolant or a propellant through the fuel element to temperature balance hot and cold spots in a nuclear reactor core.

6. The fuel element of claim 1, wherein:
a path length of the respective coolant channel exceeds a length of the fuel element.

7. The fuel element of claim 1, further comprising:
a plurality of fuel particles.

8. The fuel element of claim 7, further comprising:
an encapsulation matrix, wherein the plurality of coolant channels are formed in the encapsulation matrix;
wherein the plurality of fuel particles are disposed within the encapsulation matrix.

9. The fuel element of claim 8, wherein:
the encapsulation matrix includes graphite.

10. The fuel element of claim 8, wherein:
the encapsulation matrix is a high-temperature matrix; and
the high-temperature matrix includes silicon carbide, zirconium carbide, titanium carbide, niobium carbide, tungsten, molybdenum, or a combination thereof.

11. The fuel element of claim 7, wherein:
the plurality of fuel particles include coated fuel particles.

12. The fuel element of claim 11, wherein:
the coated fuel particles include tristructural-isotropic (TRISO) fuel particles, bistructural-isotropic (BISO) fuel particles, or TRIZO fuel particles.

13. The fuel element of claim 7, wherein:
the plurality of fuel particles are randomly packed.

14. The fuel element of claim 1, further comprising a plurality of fuel particle matrices, wherein:
each of the fuel particle matrices includes a plurality of fuel particles that spiral around the respective coolant channel.

15. A fabrication method for the fuel element of claim 1, comprising steps of:
three-dimensional printing a green body of the fuel element to form at least one twist in the plurality of coolant channels; and
placing a plurality of fuel particles in selected locations in the fuel element.

16. The fabrication method for the fuel element of claim 15, wherein the step of placing the plurality of fuel particles in the fuel element includes:
adding the plurality of fuel particles to the fuel element during or after the step of three-dimensional printing the green body of the fuel element.

17. The fabrication method for the fuel element of claim 15, further comprising.
performing chemical vapor infiltration (CVI) to solidify the fuel element.

18. The fabrication method for the fuel element of claim 17, wherein the step of placing the plurality of fuel particles in the fuel element includes adding the plurality of fuel particles to the fuel element:
(1) during the step of three-dimensional printing the green body of the fuel element;
(2) after the step of three-dimensional printing the green body of the fuel element;
(3) after partial completion of the step of performing chemical vapor infiltration;
(4) after completion of the step of performing chemical vapor infiltration; or
(5) a combination thereof.

19. The fabrication method for the fuel element of claim 15, further comprising.
performing chemical vapor deposition (CVD) to bond additional material for the encapsulation matrix to the plurality of fuel particles.

20. The fabrication method for the fuel element of claim 15, further comprising.
joining the fuel element to other fuel elements to form larger or longer fuel elements.
